(19) United States
(12) Patent Application Publication
(10) Pub. No.: US 2026/0312616 A1
(43) Pub. Date: Oct. 8, 2026

(54) SONIC BASED CONFIGURATION AND ENROLLMENT

(71) Applicant: Hewlett-Packard Development Company, L.P., Sping, TX (US)

(72) Inventors: Irwan Halim, Spring, TX (US); Jiahao Zhou, Spring, TX (US)

(73) Assignee: Hewlett-Packard Development Company, L.P., Spring, TX (US)

(21) Appl. No.: 18/998,397

(22) PCT Filed: Jul. 29, 2022
(86) PCT No.: PCT/US2022/074293

§ 371 Date: Jan. 24, 2025

(51) Int. Cl. H04B 1/66; H04B 11/00

(52) U.S. Cl. CPC H04B 1/66; H04B 11/00

(57) ABSTRACT

A computing device is prompted to receive information for connection to a remote computing device upon receiving a trigger sound. The device Sound decodes information in a sound transmission, configures itself using the decoded information, and connects to the remote computing device using the decoded information.

### BACKGROUND

Cloud computing services offer users a variety of information technology resources as a service, including the use of hardware, software, network connections and services, or a combination thereof. Users desiring cloud computing services may configure a computing device to establish a network connection to a cloud services provider and to provide authentication information to the provider's management server. After a user has enrolled a computing device for cloud services in this manner, the management server provides the computing device with access to services.

### BRIEF DESCRIPTION OF THE DRAWINGS

FIG. 1 illustrates a block diagram of an example computing device.

FIG. 2 illustrates an example method of sonic based configuration and enrollment.

FIG. 3 illustrates a block diagram of an example device with a computer-readable storage medium including instructions executable by a processor for sonic based configuration and enrollment.

FIG. 4 illustrates an example method of creating a transmission package for sonic based configuration and enrollment.

### DETAILED DESCRIPTION

A user, information technology manager, or workgroup administrator may set up computing devices for enrollment in cloud services. The set up for each computing device may include manual entry of WiFi and network settings, proxy settings, and authentication information needed to connect the computing device to a cloud management server and receive access to offerings included in the cloud services. Some computing devices may use software applications that assist in identifying needed settings and information to more efficiently configure and enroll the device. Some devices may also use unique hardware identifiers (for example, a hardware hash value) to use as authentication information for enrollment. Often each computing device is individually configured and enrolled.

This disclosure provides a mechanism for using sound transmissions to configure computing devices individually or collectively for enrollment in cloud services. In various examples, a computing device comprises a processor, a sound receiving device, a network communication device, and a memory. The computing devices, upon detecting a trigger sound, are cued to identify commands, configuration settings and authentication information in sounds that are needed to connect the computing device to a management server. Once a computing device has executed the commands, configured itself, and connected to the server, the device may be managed as a client. An administrator may, using a template, create a sound transmission containing the trigger sound, commands, configuration settings and authentication information for broadcast to computing devices to be enrolled.

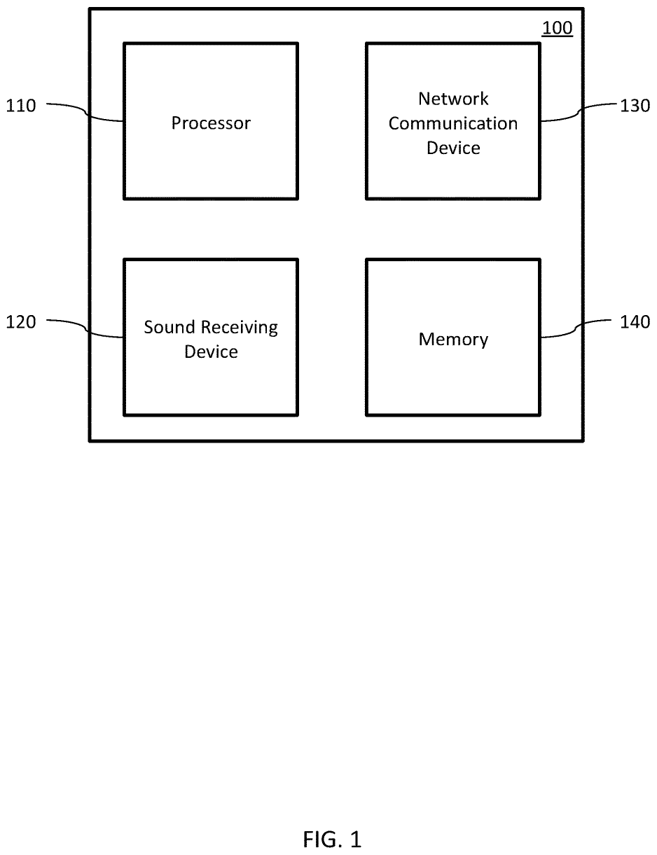

FIG. 1 illustrates an example block diagram of a computing device 100. As shown in FIG. 1, in one example, computing device 100 includes a central processing unit (CPU) or processor 110, a sound receiving device 120, a network communication device 130, and a memory 140. In this example, sound receiving device 120 is a microphone. Network communication device 130 may include an interface for wired or wireless communications with other devices over a network. For example, network communication device 130 may be a network interface card that includes an Ethernet port or a wireless communication transceiver to communicate with a wireless router or access point. Memory 140 can include random access memory (RAM) or volatile memory, a read-only memory (ROM) or non-volatile memory. ROM may be electrically erasable and programmable/reprogrammable. Memory 140 can also include a storage device such as a hard disk drive, optical disc drive, or the like. Sound receiving device 120, network communication device 130 and memory 140 are electrically connected with processor 110.

Processor 110 detects when a sound is received by sound receiving device 120 that corresponds to a pre-recorded sound stored in memory 140. Processor 110 then decodes a message included in the sound transmission received by sound receiving device 120. Decoding may include demodulation or custom techniques detailed further below. The decoded message comprises metadata (for example, addressee information and encryption information) and a message body, where the message body may include a command, configuration setting, or authentication information.

Processor 110 checks the metadata in the decoded message to determine that the content of the message body is for computing device 100. In some examples, the message body may be encrypted and require processor 110 to decrypt the information before it can be used. Processor 110 uses commands, configuration settings, and authentication information from the message body to configure network communication device 130 to connect computing device 100 to a network and establish a connection to a cloud management server. Computing device 100 is now able to access cloud services.

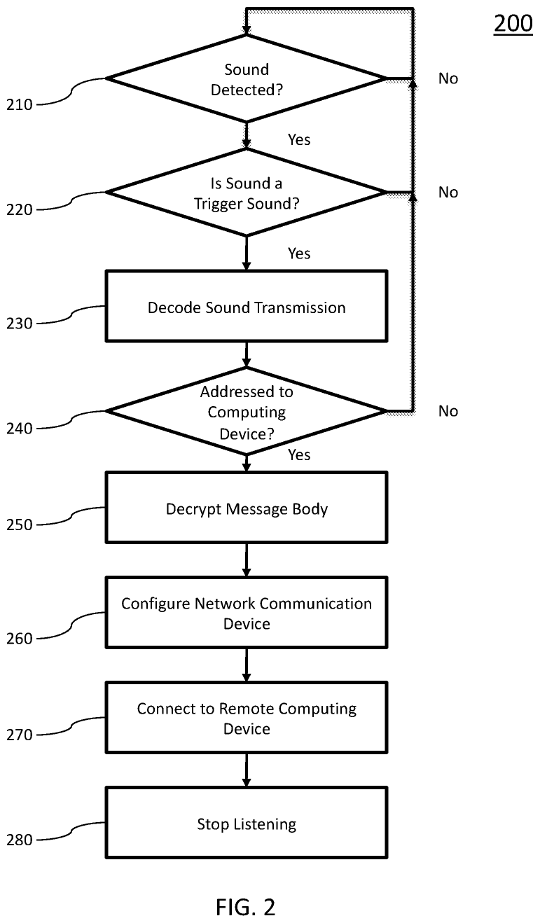

FIG. 2 illustrates an example method 200 of sonic based configuration and enrollment of this disclosure. Referring to both FIGS. 1 and 2, in Step 210, processor 110 of computing device 100 periodically checks whether a sound is received by sound receiving device 120. If no sound is received by sound receiving device 120, processor 110 repeats Step 210.

In Step 220, processor 110 compares the received sound to a pre-recorded sound, or trigger sound, stored in memory 140. This trigger sound may include, for example, a spoken word, a musical note, or modulated noise. In another example, a trigger sound may be outside the range of human hearing. If the received sound matches the trigger sound, processor 110 checks whether sound receiving device 120 receives a sound transmission following the trigger sound and proceeds to Step 230. If the received sound does not match the trigger sound, processor 110 returns to Step 210.

In Step 230, processor 110 decodes the received sound transmission. In one example, processor 110 demodulates the sound transmission using parameters (for example, carrier wave frequency, type of modulation) stored in memory 140. In another example, processor 110 decodes the transmission using custom techniques according to instructions stored in memory 140. Custom decoding techniques may include attributing data bit values to received sound frequencies based on whether the received sound frequencies in the transmission are above an arbitrary upper frequency threshold, or below an arbitrary lower frequency threshold. Processor 110 may, for example, use predefined frequency thresholds Frequency_Bit_One and Frequency_Bit_Zero, where Frequency_Bit_One has a value of 12 kHz, and Frequency_Bit_Zero has a value of 7 kHz. If sound receiving device 120 receives a sound transmission comprising sounds of frequencies 13.5 kHz, 10 kHz, 5 kHz, 8 kHz, 11 kHz, 6.5 kHz, and 17 kHz, processor 110 would use Frequency_Bit_One and Frequency_Bit_Zero to decode data bits in the transmission in the following manner: 13.5 kHz (high: 1), 10 kHz (noise), 5 kHz (low: 0), 8 kHz (noise), 11 kHz (noise), 6.5 kHz (low: 0), 17 kHz (high: 1), or 1,-,0,-,-,0,1, or 1001. Custom decoding techniques may also incorporate varying lengths of noise inserted in the sound transmission between the data bits that processor 110 ignores according to instructions stored in memory 140.

In Step 240, processor 110 checks the decoded transmission for metadata. Metadata may identify addressees by unique identification number, device characteristics, network location, or other distinguishable features. For example, the metadata may list serial numbers of devices intended as addressees, or it may identify devices that use specific models of processors as intended recipients. In another example, the metadata may identify types of devices such as laptops or smartphones as addressees. In yet another example, the metadata may identify devices by IP address or subnet. If the message is not addressed to computing device 100, processor 110 returns to Step 210.

In Step 250, processor 110 uses encryption information contained in the metadata to decrypt the non metadata portion of the decoded transmission, that is, the message body. For example, the metadata may specify an encryption type or a particular encryption key stored in memory 140 that is to be used to decrypt the message body.

The decoded and decrypted message body may contain information needed for computing device 100 to connect to a cloud services provider. For example, the message body may contain commands, configuration settings, and authentication information. The message body may include a command to connect to a nearby wireless network using wireless access point identification, security and password information also included in the message body. The message body may include proxy server address and port information. The message body may include commands for processor 110 to launch a web browser application. The message body may include particular universal resource locator (URL) or IP address and port settings to be used. The message body may also include authentication information, for example, credentials, digital certificate information, or a security token.

In Step 260, processor 110 configures the network communication device 130 to connect to a cloud services provider, using information from the message body. Processor 110 may establish a connection to a local area network using, for example, wireless network information contained in the message body, if computing device 100 is not currently connected to a network. Processor 110 may use proxy information and network address information contained in the message body to configure network communication device 130.

In Step 270, processor 110, via network communication device 130, connects to a cloud services provider (for example, a cloud management server or proxy for the cloud management server) using authentication information contained in the message body.

In Step 280, processor 110, having established a network connection to a cloud services provider via network communication device 130, stops checking whether a trigger sound has been received by sound receiving device 120.

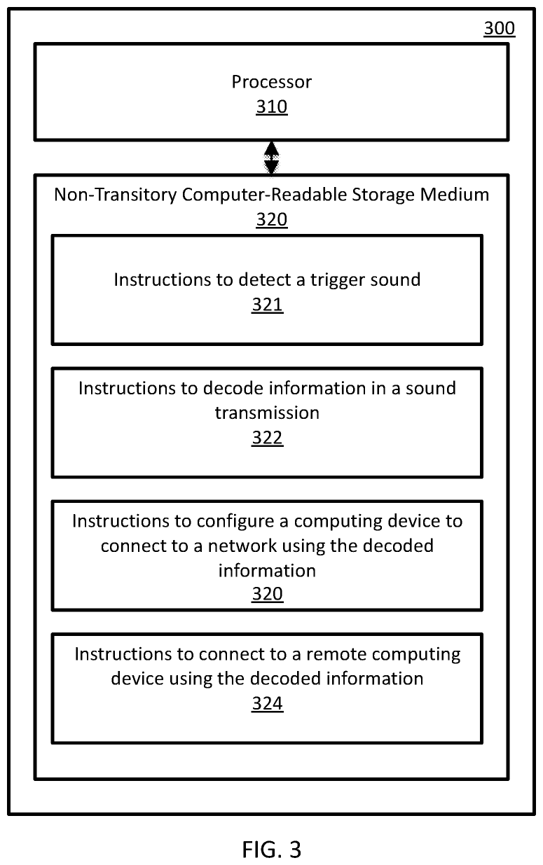

FIG. 3 illustrates a block diagram of an example device with a computer-readable storage medium including instructions executable by a processor for sonic based configuration and enrollment. The device 300 includes a processor 310 and a non-transitory computer-readable storage medium 320. The non-transitory computer-readable storage medium 320 includes example instructions 321-324 executable by the processor 310 to perform various functionalities described herein. In various examples, the non-transitory computer-readable storage medium 320 may be random access memory (RAM) or volatile memory, a read-only memory (ROM), where the ROM may be electrically erasable and programmable/reprogrammable, or non-volatile memory. The non transitory computer-readable storage medium 320 may also be magnetic disks (for example, internal hard disks) or optical discs (for example, compact discs (CD), digital video discs (DVD), or blu-ray discs (BD)). Processor 310 may be a general purpose processor, special purpose logic, or the like. Instructions 321-324 may exist as a software program in the form of source code, object code, executable code, or other formats.

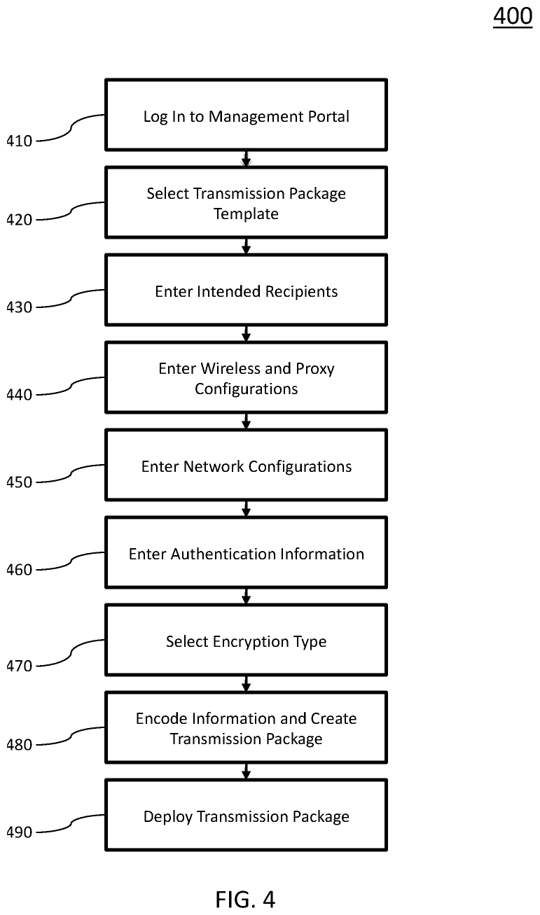

FIG. 4 illustrates an example method 400 of creating a transmission package for sonic based configuration and enrollment. In Step 410, an administrator logs in to a management portal of a cloud services provider using a web browser.

In Step 420, the administrator selects the transmission package template from an available list of options.

In Step 430, the administrator enters information identifying intended recipient devices of the transmission package into the template. As noted elsewhere, intended recipient devices may be identified by unique identification number, device characteristics, network location, or other distinguishable features.

In Step 440, the administrator enters wireless and proxy configurations into the template. For example, the administrator may specify information including wireless access point identification, security and password information, proxy server address, or port information.

In Step 450, the administrator enters network configurations relating to the cloud services provider into the template. For example, the administrator may specify information including a particular universal resource locator (URL), IP address, or port setting to be used.

In Step 460, the administrator enters authentication information into the template. For example, the administrator may enter information including credentials, digital certificate information, or a security token.

In Step 470, the administrator enters the type of encryption method desired into the template.

In Step 480, the administrator encodes information in the completed template into a sound transmission. If encryption is selected in the template, the configuration and authentication information is encrypted before encoding. The encoded transmission is paired with a trigger sound forming a complete transmission package. As described elsewhere, the information may be encoded by custom techniques (for example, using predefined upper and lower frequency thresholds) or modulated.

In Step 490, the administrator deploys the transmission package to configure and enroll the intended recipient devices. Deployment of the transmission package may include associating the transmission package with a network location that is accessible to other devices, sending the transmission package to a computing device where the computing device can play the transmission package near recipient devices, or otherwise making the transmission package available to be played near recipient devices. For example, the administrator may associate the transmission package with a URL, allowing a device accessing the URL to play the transmission package. The administrator may then include the URL in a welcoming email sent to new employees. A new employee may open the email on a personal computing device (for example, a smartphone), click on the URL, and play the transmission package through the smartphone near a newly purchased computing device (for example, a laptop or desktop personal computer). In this manner, the newly purchased computing device is configured and enrolled in cloud services.

In another example, the administrator may play the transmission package from a speaker attached to the administrator's computing device. If the administrator is part of a large organization, and the administrator's computing device has access to room speakers located throughout the organization's campus, the administrator may play the transmission package over the room speakers, emitting sound waves corresponding to the trigger sound and encoded sound transmission in each room and simultaneously configuring and enrolling all intended recipients on the campus.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation 6 may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure as stated in the appended claims. It should also be noted that not all of the steps or features described in the figures in this disclosure are required in all embodiments.

What is claimed is:

1. A computing device, comprising:
a sound receiving device;
a network communication device;
a memory; and
a processor to:
determine when a trigger sound is received by the sound receiving device, wherein the trigger sound is identifiable as a pre-recorded sound stored in the memory;
decode information in a sound transmission received by the sound receiving device in response to the trigger sound;
configure the network communication device according to the decoded information; and
connect, via the network communication device, with a remote computing device using the decoded information.

2. The computing device of claim 1, wherein information in a sound transmission is encrypted, the processor to decrypt encrypted information in a sound transmission.

3. The computing device of claim 1, wherein the processor to decode the information in the sound transmission received by the sound receiving device comprises the processor to compare the sound transmission to predefined frequency thresholds.

4. The computing device of claim 3, wherein the predefined frequency thresholds include a high sound frequency and a low sound frequency, wherein portions of the sound transmission having a frequency between the high and low sound frequencies represent noise.

5. The computing device of claim 1, wherein information in the sound transmission comprises wireless network information sufficient to establish a connection to a wireless network or authentication information.

6. A method, comprising:
detecting a trigger sound;
decoding information in a sound transmission in response to the detection of the trigger sound;
configuring network settings of a computing device using the decoded information; and
establishing a connection to a remote computing device using the decoded information.

7. The method of claim 6, comprising decrypting encrypted information in the sound transmission.

8. The method of claim 6, wherein decoding information in the sound transmission comprises comparing the sound transmission to predefined frequency thresholds.

9. The method of claim 8, wherein the predefined frequency thresholds include a high sound frequency and a low sound frequency, wherein portions of the sound transmission having a frequency between the high and low sound frequencies represent noise.

10. The method of claim 6, wherein decoding information in the sound transmission comprises decoding wireless network information or authentication information.

11. A non-transitory computer readable storage medium encoded with instructions executable by a processor of a computing system, the instructions when executed by the processor causing the processor to:
detect a trigger sound;
decode information in a sound transmission in response to the trigger sound;
configure a computing device to connect to a network using the decoded information; and
connect to a remote computing device using the decoded information.

12. The non transitory computer readable storage medium of claim 11, wherein the instructions further cause the processor to decrypt encrypted information in the sound transmission.

13. The non-transitory computer-readable storage medium of claim 11, wherein the instructions causing the processor to decode information in a sound transmission comprises instructions further causing the processor to compare the sound transmission to predefined frequency thresholds.

14. The non-transitory computer-readable storage medium of claim 13, wherein the predefined frequency thresholds include a high sound frequency and a low sound frequency, wherein portions of the sound transmission having a frequency between the high and low sound frequencies represents noise.

15. The non transitory computer-readable storage medium of claim 11, wherein information in a sound transmission comprises wireless network information or authentication information.

16. A method, comprising:
encoding a message into a sound transmission, wherein the message comprises: designated intended recipient information and configuration and connection information;
pairing the sound transmission with a trigger sound to form a sound transmission package; and
deploying the sound transmission package to be played at a physical location proximate to a computing device.

17. The method of claim 16, further comprising emitting sound waves corresponding to the sound transmission package from a speaker to a plurality of computing devices capable of receiving audio signals.

18. The method of claim 16, wherein encoding the message comprises sorting the message information according to predefined frequency thresholds.

19. The method of claim 18, wherein the predefined frequency thresholds include a high sound frequency and a low sound frequency, wherein portions of the sound transmission having a frequency between the high and low sound frequencies represent noise.

20. The method of claim 16, wherein configuration and connection information comprises wireless network information or authentication information.
